(19) United States
(12) Patent Application Publication
(10) Pub. No.: US 2014/0057038 A1
(43) Pub. Date: Feb. 27, 2014

(54) PROCESS OF OBTAINING A CHIA BASED ENERGY DRINK

(71) Applicants: Janice Da Silva, Porto Alegre (BR); Suse Botelho Da Silva, Canoas (BR); Gabriela Raimann, Nova Petropolis (BR)

(72) Inventors: Janice Da Silva, Porto Alegre (BR); Suse Botelho Da Silva, Canoas (BR); Gabriela Raimann, Nova Petropolis (BR)

(21) Appl. No.: 13/965,831

(22) Filed: Aug. 13, 2013

(30) Foreign Application Priority Data
Aug. 24, 2012 (BR) 102012021283-8

(51) Int. Cl. A23L 2/52

(52) U.S. Cl. CPC A23L 2/52
USPC 426/548

(57) ABSTRACT

Process of obtaining a chia based energy drink able to combine the stimulating properties of compounds such as taurine, caffeine and inositol with the anti-oxidizing benefits of the chia seed, retrieving a traditional beverage, “cool chia” in the form of an industrialized product, allowing for the effective use of the combination of raw materials used for the composition of the beverage benefiting health, in terms of neurologic functions, as it is a stimulant, as well as in terms of weight control, as it is an antioxidant and a low-calorie energy source for the body, controlling cholesterol and triglycerides and regulating the intestine.

### BACKGROUND OF THE INVENTION

1. Field of the Invention

The following descriptive report for the present patent application concerns the development of a process of obtaining a drink based on chia, able to combine the stimulating properties of compounds such as taurine, caffeine and inositol with the anti-oxidizing benefits of the chia seed, retrieving a traditional beverage, “cool chia”, in the form of an industrialized product.

This process allows for the effective use of a combination of raw materials used for the composition of the beverage benefiting health, in terms of neurologic functions, as it comprises a stimulant, and in terms of weight control, as it comprises an antioxidant and a low-calorie source of energy for the body, controlling cholesterol and triglycerides and regulating the intestine.

The composition of chia can be compared with that of other mucilaginous seeds such as linseed and psyllium. Unlike linseed, chia does not contain anti-nutritional factors, factors that in linseed constrain its use without preliminary cooking. The anti-nutritional factors consist of cyanogenic glycosides or linatine, which are vitamin B6 antagonists, this actually means they prevent vitamin B6 from acting on metabolism. In addition, chia has a far more pleasant taste than linseed.

2. Description of the Related Art

The use of combinations of extracts derived from vegetables for stimulating neurologic activities and moderating the consumption of calories and regulating digestive functions is widely understood in the prior art.

The high total antioxidant activity (TAA) observed for the chia seed may be attributed to the flavonoids present in the seed, such as myricetin, quercetin, kaempferol, chlorogenic acid and caffeic acid; as well as the effectiveness of the extraction process of the seed compounds for the aqueous extract (MUÑOZ et al., 2012; PEIRETTI; GAI, 2009). These compounds are classified as mixed antioxidants that have been widely studied as antioxidants in food. Among these are several hydrolyzed proteins, flavonoids and cinnamic acid derivatives (caffeic acid) (RAMALHO; JORGE, 2006). The total antioxidant activity of the developed chia-based energy drink was established in triplicate by DPPH (1,1-diphenyl-2-picrylhydrazyl) testing, which consists of removing the stable radical DPPH from the reaction medium by the action of the antioxidants available in the sample. After addition of the sample, the discoloration degree of the radical DPPH was measured at 517 nm using a spectrophotometer Bioespectro SP-22 (BORGUINI, 2006; ROCHA; SILVA, 2011).

To conduct the comparative test, an ascorbic acid (Vitamin C) solution was prepared, at the same concentration of the seed in the extract. The analysis of the antioxidant activity of the developed chia-based energy drink resulted in 83.9%±2.0 of TAA, and the result was close to that shown by ascorbic acid (94.7%±0.6), considered to be a natural antioxidant usually added in the formulation of foodstuffs with the purpose to increase their shelf life.

By researching the prior art relative to the technical field of the invention, only patent PI0916752-8 was found, filed with the federal office on Jul. 27, 2008, concerning an invention patent for a chia-based foodstuff made up of fatty acids, rich in Omega-3, with good stability and readily soluble (miscible) in water; however, this property does not clash with any characteristic present in the process in this report.

### SUMMARY OF THE INVENTION

Therefore, due to the considerations relative to the previously reported prior art, one of the objects of the present application for an invention patent is the process of obtaining an energy drink based on chia seed which intends to benefit health, in terms of neurologic functions, as it comprises a stimulant, and in terms of weight control, as it comprises an antioxidant and a low-calorie energy source for the body, controlling cholesterol and triglycerides and regulating the intestine.

These and other objects, features and advantages of the present invention will become clearer when the drawings as well as the detailed description are taken into consideration.

### BRIEF DESCRIPTION OF THE DRAWINGS

The characterization of the utility model application is done through representative drawings (flow chart) of the process of obtaining the energy drink based on chia seed, in such a way that the object may be reproduced through suitable technology, allowing for the full characterization of the functionality and exclusivity of the claimed object.

The drawn figures, which express the best embodiment or preferential embodiment of the process herein idealized, substantiate the descriptive portion of the report, where aspects that may be implicit in the adopted representation are clarified, so as to clearly determine the protection for which we have applied.

These figures are merely illustrative and may have variations, as long as they do not deviate from the principle initially claimed.

In this case:

FIG. 1 illustrates a flow chart of the claimed process.

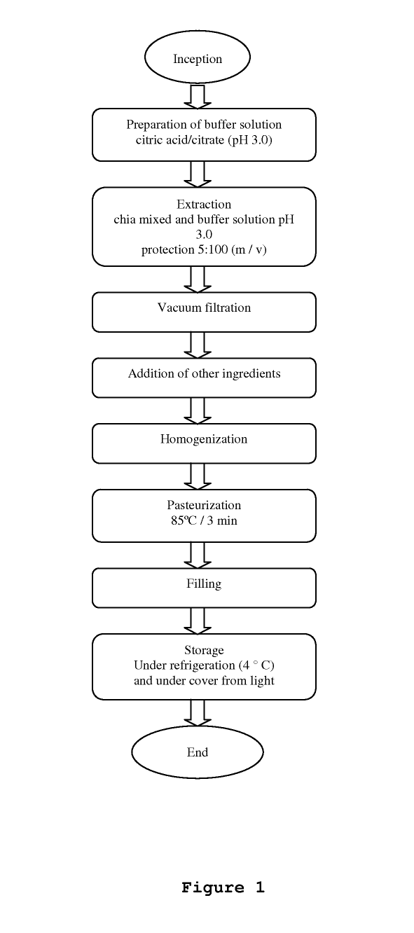

The quantities indicated in the process may present variations, as long as they do not deviate from the initially required ratio. In this case, the product can be generated by different formulations.

### DETAILED DESCRIPTION OF THE PREFERRED EMBODIMENT

The characterization of the invention proposed in this report is achieved by describing the process in question, necessary for the present application, in such a way that it can be fully reproduced using a suitable technique, allowing for the full characterization of the functionality of the patent for which we have applied.

Therefore, the process comprises phases as described below:

Obtaining an aqueous extract: Citric acid and sodium citrate solutions are prepared, adjusting pH to 3.0±0.05. The buffer solution achieved is heated to 40° C.

Extraction: The crushed seed and buffer solution are mixed at the ratio (m/v) of (5:100), respectively. The previously achieved mixture is transferred to a shaker, for 15 minutes, under rotation at 150 rpm and at a temperature of 40° C.

Filtration: After the extraction process, the solution is filtered under vacuum and a clear liquid is achieved which will be used as the formulation base.

Mixture of ingredients: Other ingredients are added to the liquid achieved through filtration, such as sucralose, taurine, caffeine, inositol, aroma and Complex B vitamins.

Homogenization: The beverage is then homogenized until full dissolution of the added ingredients.

Pasteurization: After homogenization, the beverage is submitted to the pasteurization process, which is carried out at 85° C. for 3 minutes.

Filling: The beverage is filled into a specific recipient.

Storage: Storage is carried out under refrigeration at 4° C. and protected from light in order to maintain its characteristics.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

1. (canceled)

2. A process for preparing a chia based energy drink comprising:
preparing a buffer solution comprising citric acid and sodium citrate,
adjusting the buffer solution to a pH of about 3,
heating the buffer solution to about 40 degrees Celsius,
preparing an extraction solution by adding an amount of crushed chia seed with an amount of the buffer solution in a mass to volume ratio of about 5 to 100,
mixing the extraction solution for about 15 minutes at a speed of about 150 revolutions per minute and a temperature of about 40 degrees Celsius,
filtering the extraction solution under a vacuum and obtaining a clear filtrate,
preparing a base solution by mixing a plurality of additives into the clear filtrate, wherein the plurality of additives comprises sucralose, taurine, caffeine, inositol, aroma and Complex B vitamins,
homogenizing the base solution until the plurality of additives have substantially dissolved,
pasteurizing the base solution at about 85 degrees Celsius for about 3 minutes to obtain the chia based energy drink,
bottling the chia based energy drink, and
storing the bottled chia based energy drink under refrigeration at about 4 degrees Celsius in an area protected from light.
